(19) United States
(12) Patent Application Publication
(10) Pub. No.: US 2022/0044436 A1
(43) Pub. Date: Feb. 10, 2022

(54) POSE DATA PROCESSING METHOD AND SYSTEM

(71) Applicant: BEIJING DIDI INFINITY TECHNOLOGY AND DEVELOPMENT CO., LTD., Beijing (CN)

(72) Inventors: Sheng Yang, Beijing (CN); Teng Ma, Beijing (CN)

(73) Assignee: BEIJING DIDI INFINITY TECHNOLOGY AND DEVELOPMENT CO., LTD., Beijing (CN)

(21) Appl. No.: 17/451,838

(22) Filed: Oct. 22, 2021

Related U.S. Application Data
(63) Continuation of application No. PCT/CN2020/086784, filed on Apr. 24, 2020.

(30) Foreign Application Priority Data
Apr. 25, 2019 (CN) 201910339237.5

(51) Int. Cl. G06T 7/70; G06T 7/20; G06F 17/16; G06F 16/901

(52) U.S. Cl. CPC G06T 7/70; G06T 7/20; G06T 2200/04; G06F 16/9024; G06F 17/16

(57) ABSTRACT

The present application is directed to a method and a system for processing pose data. The method and the system may be applied to a map generation device, the map generation device being coupled to a global positioning system and a pose sensing system, the global positioning system being configured for outputting positioning data, the pose sensing system being configured for outputting motion pose data, and the positioning data and the motion pose data being combined to generate pose estimation data. The method for processing pose data includes: determining, in response to generated positioning data, positioning accuracy information corresponding to the positioning data; determining a degree of confidence of the pose estimation data according to the positioning accuracy information; and generating optimized pose data by processing the pose estimation data according to the degree of the confidence of the pose estimation data.

### CROSS-REFERENCE TO RELATED APPLICATIONS

The present application is a continuation of International Patent Application No. PCT/CN2020/086784, filed on Apr. 24, 2020, which claims the priority to Chinese Patent Application No. 201910339237.5, filed on Apr. 25, 2019, the contents of each of which are hereby incorporated by reference.

### TECHNICAL FIELD

The present application relates to positioning technology, in particular to a method and a system for processing pose data.

### BACKGROUND

In order to obtain high-definition maps, a map generation device is equipped with a vision sensor, a laser sensor, an inertial sensor, etc., besides a global positioning system (GPS), so as to repair and optimize, to a certain extent, poor communication quality of GPS signals received by the GPS. In related arts, the map generation device can keep, through the Extended Kalman filter algorithm, positioning for a certain period when the GPS signal degrades in quality or even lost, but a positioning accuracy may keep declining until lost due to accumulation of uncertainty over time. The decline of the positioning accuracy affects the quality of the high-definition maps dramatically, and the accumulation of uncertainty leads to a global inconsistency of point clouds.

In the prior art, weights of edges in pose graphs are not distinguished during optimization, resulting in poor effect for eliminating accumulative errors. Therefore, it is necessary to provide a method and system for processing pose data (also referred to as position and attitude data) more accurately, so as to optimize each region to different extents.

### SUMMARY

One embodiment of the present application provides a method for processing pose data (also referred to as position and attitude data). The method may be applied to a map generation device, the map generation device being coupled to a global positioning system and a pose sensing system, the global positioning system being configured for outputting positioning data, the pose sensing system being configured for outputting motion pose data, and the positioning data and the motion pose data being combined to generate pose estimation data, where the method for processing pose data includes: determining, in response to generated positioning data, positioning accuracy information corresponding to the positioning data; determining a degree of the confidence of the pose estimation data according to the positioning accuracy information; and generating optimized pose data by processing the pose estimation data according to the degree of the confidence of the pose estimation data.

One embodiment of the present application provides a system for processing pose data. The system may be applied to a map generation device, the map generation device being coupled to a global positioning system and a pose sensing system, the global positioning system being configured for outputting positioning data, the pose sensing system being configured for outputting motion pose data, and the positioning data and the motion pose data being combined to generate pose estimation data, where the system for processing pose data includes: determining, in response to generated positioning data, positioning accuracy information corresponding to the positioning data; determining a degree of the confidence of the pose estimation data according to the positioning accuracy information; and generating optimized pose data by processing the pose estimation data according to the degree of the confidence of the pose estimation data.

One embodiment of the present application provides a system for processing pose data. The system may be applied to a map generation device, the map generation device being coupled to a global positioning system and a pose sensing system, the global positioning system being configured for outputting positioning data, the pose sensing system being configured for outputting motion pose data, and the positioning data and the motion pose data being combined to generate pose estimation data, where the system for processing pose data includes: a first determination module configured for determining, in response to generated positioning data, positioning accuracy information corresponding to the positioning data; a second determination module configured for determining a degree of the confidence of the pose estimation data according to the positioning accuracy information; and an optimization module configured for generating optimized pose data by processing the pose estimation data according to the degree of the confidence of the pose estimation data.

One embodiment of the present application provides a method for processing pose data. The method may be applied to a map generation device, the map generation device being coupled to a global positioning system and a pose sensing system, the global positioning system being configured for outputting positioning data, the pose sensing system being configured for outputting motion pose data, and the positioning data and the motion pose data being combined to generate pose estimation data, where the method for processing pose data includes: determining, in response to generated positioning data, positioning accuracy information corresponding to the positioning data; and determining a degree of the confidence of the pose estimation data according to the positioning accuracy information.

In some embodiments, the determining a degree of the confidence of the pose estimation data according to the positioning accuracy information specifically includes: generating front-end mileage estimation data corresponding to the pose estimation data by inputting the positioning accuracy information, the positioning data and the motion pose data into an Unscented Kalman Filter; and determining one or more groups of point clouds by performing a time-space coherence division on the front-end mileage estimation data, and constructing a corresponding pose graph according to each of the one or more groups of point clouds, where an output result of the Unscented Kalman Filter includes the degree of the confidence.

In some embodiments, the determining one or more groups of point clouds by performing a time-space coherence division on the front-end mileage estimation data, and constructing a corresponding pose graph according to each of the one or more groups of point clouds specifically includes: determining edges of a first type in the pose graph by dividing the front-end mileage estimation data according to a preset time interval; determining edges of a second type in the pose graph by dividing the front-end mileage estimation data according to a preset space interval; and resolving a motion trajectory from the motion pose data, generating, through splicing, each of the one or more groups of point clouds according to a continuity of the motion trajectory, and determining a first frame of point cloud in each group of point clouds as a vertex of the pose graph.

In some embodiments, the method further includes: determining an inverse matrix of the covariance matrix output by the Unscented Kalman Filter, and recording the inverse matrix as an information matrix of the edges of the first type; and determining another inverse matrix of the covariance matrix generated during registration by performing a registration on any two groups of point clouds in the one or more groups of point clouds, and recording the another inverse matrix as an information matrix of the edges of the second type.

In some embodiments, the method further includes: determining the information matrix of the edges of the first type according to at least one preset hardware parameter of the map generation device and/or a signal intensity of the positioning data.

In some embodiments, the method further includes: correcting a three-dimensional position of each group of point clouds in the pose graph according to the information matrix of the edges of the first type and the information matrix of the edges of the second type.

In some embodiments, the determining the information matrix of the edges of the first type according to at least one preset hardware parameter of the map generation device and/or a signal intensity of the positioning data specifically includes: determining a parameter dimension of the pose estimation data according to the preset hardware parameter of the map generation device and/or the signal intensity of the positioning data; and setting a preset weight corresponding to the parameter dimension as a value of a diagonal matrix, and determining the information matrix of the edges of the first type according to the diagonal matrix.

In some embodiments, the parameter dimension includes at least one of an absolute position in the north, absolute position in the east, an absolute position towards ground, a roll angle, a pitch angle and a yaw angle.

In some embodiments, the pose sensing system includes at least one of a vision sensor, a laser sensor and an inertial sensor.

In some embodiments, the global positioning system includes a positioning board and a satellite communication antenna.

One embodiment of the present application provides a system for processing pose data. The system may be applied to a map generation device, the map generation device being coupled to a global positioning system and a pose sensing system, the global positioning system being configured for outputting positioning data, the pose sensing system being configured for outputting motion pose data, and the positioning data and the motion pose data being combined to generate pose estimation data, where the system for processing pose data includes: a processor, the processor executing the following steps: determining, in response to generated positioning data, positioning accuracy information corresponding to the positioning data; and determining a degree of the confidence of the pose estimation data according to the positioning accuracy information.

One embodiment of the present application provides a map generation device. The map generation device includes a memory, a controller and a computer program which may be stored in the memory, and may be run on the controller, where the controller implements the method for processing pose data in any embodiment of the present application when executing the computer program.

One embodiment of the present application provides a computer readable storage medium, the storage medium storing a computer instruction, where after a computer reads the computer instruction in the storage medium, the computer executes the method in any embodiment of the present application.

### BRIEF DESCRIPTION OF THE DRAWINGS

The present application will be further described by way of exemplary embodiments, which will be described in detail through the accompanying drawings. These embodiments are not limiting, and in these embodiments, the same reference numerals refer to the same structures. In the accompanying drawings,

FIG. 1 is a schematic diagram of an application scenario of a pose data processing system according to some embodiments of the present application;

FIG. 2 is a schematic diagram of modules of the system for processing pose data according to some embodiments of the present application;

FIG. 3 is an exemplary flowchart of a method for processing pose data according to some embodiments of the present application;

FIG. 4 is an exemplary flowchart of a method for determining a degree of the confidence of pose estimation data according to some embodiments of the present application;

FIG. 5 is a schematic block diagram of a map generation device according to some embodiments of the present application;

FIG. 6 is a schematic block diagram of a map generation device according to some other embodiments of the present application; and

FIG. 7 is a schematic diagram illustrating the effect of optimizing pose estimation data according to some embodiments of the present application.

### DETAILED DESCRIPTION

In order to describe the technical solutions in embodiments of the present application more clearly, the following briefly describes the accompanying drawings required in descriptions of the embodiments. Apparently, the accompanying drawings in the following descriptions may be merely some examples or embodiments of the present application, and a person of ordinary skill in the art may apply the present application to other similar scenes according to these accompanying drawings without creative efforts. Unless obvious from a language environment or otherwise stated, the same reference numerals in the accompanying drawings represent the same structure or operation.

It should be understood that “systems”, “apparatuses”, “units” and/or “modules” used herein may be a method for distinguishing different components, elements, parts, portions or assemblies at different levels. However, if other words may achieve the same purpose, the above words may be replaced by other expressions.

As shown in the present application and the claims, unless the context clearly suggests exceptional circumstances, the words “one”, “an”, “a” and/or “the”, etc. do not mean the singular, but may also include the plural. Generally speaking, the terms “comprising” and “including” merely imply that steps and elements that have been clearly identified may be included, but these steps and elements do not constitute an exclusive list, and the method or the device may also include other steps or elements.

In the present application, a flowchart may be configured to describe operations executed by the system according to the embodiment of the present application. It should be understood that the preceding or following operations may not be necessarily executed accurately in order. On the contrary, the steps may be processed in reverse order or simultaneously. At the same time, other operations may also be added into these procedures, or one or several operations may be removed from these procedures.

The embodiment of the present application may be applied to different transportation systems, such as taxis, tailored taxis, ride sharing, buses, substitute driving, etc. The terms “passenger”, “passenger side”, “passenger terminal”, “customer”, “demander”, “service demander”, “service requester”, “consumer”, “consumer party”, “user demander”, etc. described in the present application may be interchangeable, and refer to a party who needs or subscribes to services, which may be an individual or a tool. Similarly, “driver”, “driver side”, “driver terminal”, “provider”, “supplier”, “service provider”, “servant”, “service party”, etc. described in the present application may be interchangeable, and refer to an individual, a tool or other entity that provides services or assists in providing services. In addition, the “user” described in the present application may be one party who needs or subscribes to services, and may also be one party who provides services or assists in providing services.

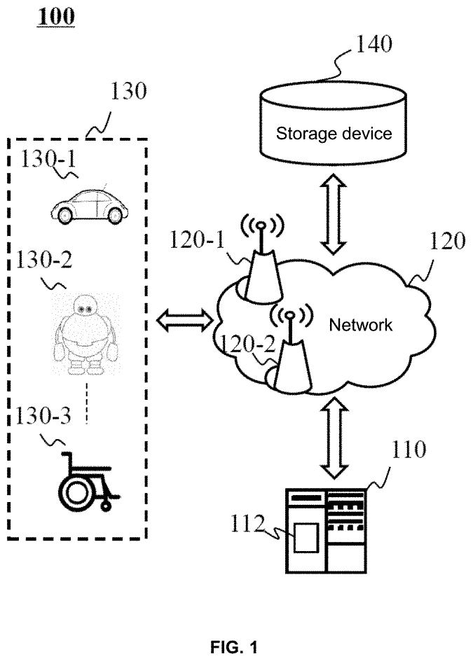

FIG. 1 is a diagram of an application scenario of a pose data processing system 100 according to some embodiments of the present application.

The pose data processing system 100 may be an online platform for obtaining high-definition map. The pose data processing system 100 may include a server 110, a network 120, an acquisition terminal 130 and a storage device 140.

In some embodiments, the server 110 may be configured to process information and/or data related to high-definition map acquisition. For example, the server 110 may process data collected by the acquisition terminal 130 and optimize a pose graph, so as to improve positioning accuracy of areas with poor global positioning system (GPS) signals. In some embodiments, the server 110 may be a single server or a server group. The server group may be centralized or distributed (for example, the server 110 may be a distributed system). In some embodiments, the server 110 may be local or remote. For example, the server 110 may access information and/or data stored in the acquisition terminal 130 and the storage device 140 through the network 120. As another example, the server 110 may be directly connected to the acquisition terminal 130 and the storage device 140 to access the stored information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, multi-clouds, or the like, or any combination of thereof.

The network 120 may facilitate exchange of information and/or data. In some embodiments, one or more components (for example, the server 110, the acquisition terminal 130 and the storage device 140) in the pose data processing system 100 may send to or receive from other components in the pose data processing system 100 information and/or data pose data processing system 100 through the network 120. For example, the server 110 may receive collected data (for example, positioning data or motion pose data) from the acquisition terminal 130 through the network 120. In some embodiments, the network 120 may be a wired or wireless network of any form or any combination thereof. Merely by way of example, the network 120 may include a cable network, a wired network, an optical fiber network, a telecommunication network, an internal network, the Internet, a local area network (LAN), a wide area network (WAN), a wireless local area network (WLAN), a metropolitan area network (MAN), a wide area network (WAN), a public switched telephone network (PSTN), a Bluetooth network, a ZigBee network, a near field communication (NFC) network, a network of global system for mobile communications (GSM), a code division multiple access (CDMA) network, a time division multiple access (TDMA) network, a general packet radio service (GPRS) network, a network of enhanced data rate for GSM evolution (EDGE), a wideband code division multiple access (WCDMA) network, a high speed downlink packet access (HSDPA) network, a long term evolution (LTE) network, a user datagram protocol (UDP) network, a transmission control protocol/internet protocol (TCP/IP) network, a short messaging service (SMS) network, a wireless application protocol (WAP) network, an ultra-wideband (UWB) network, an infrared ray, etc. or any combination thereof. In some embodiments, the pose data processing system 100 may include one or more network access points. For example, the pose data processing system 100 may include wired or wireless network access points, such as base stations and/or wireless access points 120-1, 120-2, . . . , through which the one or more components of the pose data processing system 100 may be connected to the network 120 to exchange data and/or information.

In some embodiments, the acquisition terminal 130 may be used as a device for collecting data. In some embodiments, the acquisition terminal 130 may be used as a system for analyzing and processing collected data to generate an analysis result. In some embodiments, the acquisition terminal 130 may include an autonomous vehicle 130-1, a robot 130-2, and an autonomous wheelchair 130-3, or any combination thereof. In some embodiments, the acquisition terminal 130 may be a device which employs a positioning technology and may sense surrounding environment. The acquisition terminal 130 may be configured to position the acquisition terminal 130 and detecting a surrounding obstacle. For example, the acquisition terminal 130 may include a GPS receiver, a laser radar, an inertial sensor, a camera (such as a monocular, binocular, or panorama camera), etc. In some embodiments, the acquisition terminal 130 may send positioning information and surrounding environment information to the server 110.

The storage device 140 may store data and/or instructions related to the high-definition map acquisition. In some embodiments, the storage device 140 may store data obtained/acquired from the acquisition terminal 130. In some embodiments, the storage device 140 may store data and/or instructions used by the server 110 to execute or implement an exemplary method described in the present application. In some embodiments, the storage device 140 may include a mass storage, a removable memory, a volatile read-write memory, a read-only memory (ROM), etc. or any combination thereof. An exemplary mass storage may include a magnetic disk, an optical disk, a solid-state disk, etc. An exemplary removable memory may include a flash drive, a floppy disk, an optical disk, a memory card, a compact disk, a magnetic tape, etc. An exemplary volatile read-only memory may include a random access memory (RAM). An exemplary RAM may include a dynamic random access memory (DRAM), a double data rate synchronous dynamic random access memory (DDR SDRAM), a static random access memory (SRAM), a thyristor random access memory (T-RAM), a zero-capacitor random access memory (Z-RAM), etc. An exemplary ROM may include a mask read-only memory (MROM), a programmable read-only memory (PROM), an erasable programmable read-only memory (EPROM), an electronically erasable programmable read-only memory (EEPROM), a compact disc read-only memory (CD-ROM), a digital versatile disc ROM, etc. In some embodiments, the storage device 140 may be implemented on the cloud platform. Merely by way of example, the cloud platform may include a private cloud, a public cloud, a hybrid cloud, a community cloud, a distributed cloud, an internal cloud, a multi-layer cloud, etc. or any combination thereof.

In some embodiments, the storage device 140 may be connected to the network 120, so as to communicate with one or more components (for example, the server 110 and the acquisition terminal 130) in the pose data processing system 100. One or more components in the pose data processing system 100 may access data or instructions stored in the storage device 140 through the network 120. In some embodiments, the storage device 140 may be directly connected or communicate with one or more components (for example, the server 110 and the acquisition terminal 130) in the pose data processing system 100. In some embodiments, the storage device 140 may be a portion of the server 110.

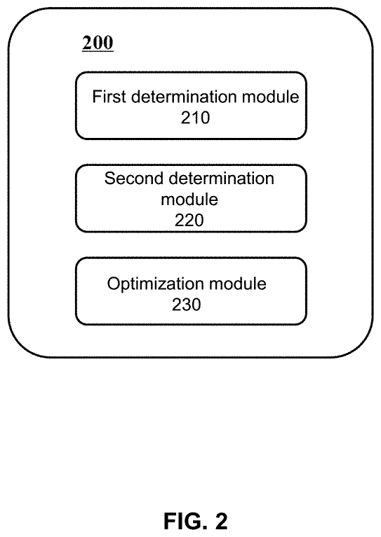

FIG. 2 is a schematic diagram of modules of the system for processing pose data according to some embodiments of the present application.

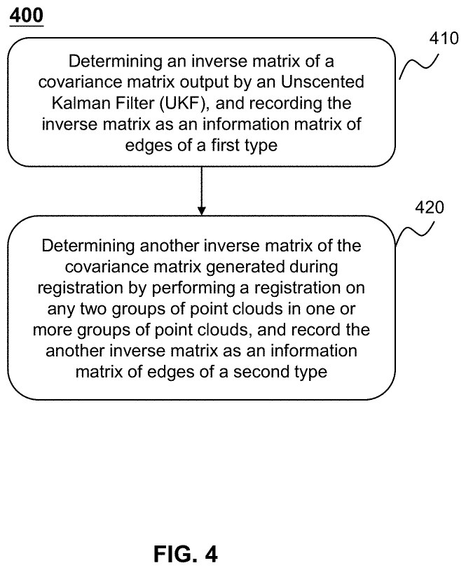

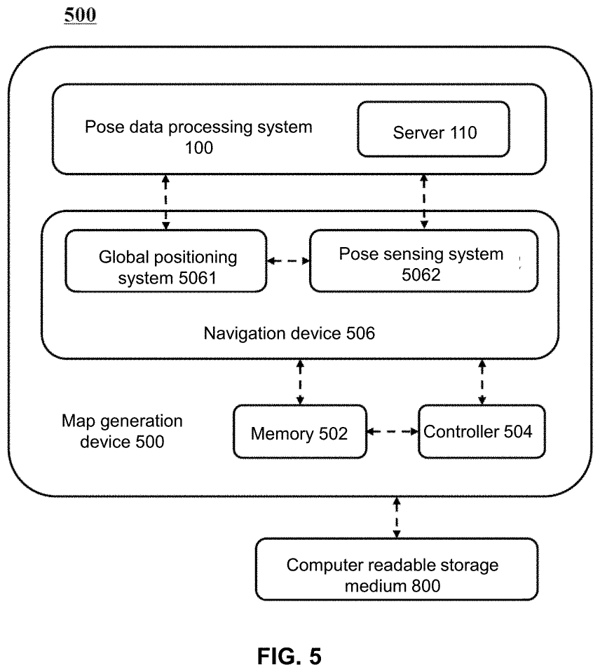

The system 200 for processing pose data (also referred to as position and attitude data) may be applied to a map generation device, the map generation device being coupled to a global positioning system and a pose sensing system, the global positioning system being configured for outputting positioning data, the pose sensing system being configured for outputting motion pose data, and the positioning data and the motion pose data being combined to generate pose estimation data. Descriptions of FIG. 4 and FIG. 5 may be referred to for more contents of the map generation device, which may not be repeated herein.

As shown in FIG. 2, the system 200 may include a first determination module 210, a second determination module 220, and an optimization module 230.

The first determination module 210 may be configured for determining, in response to the generated positioning data, positioning accuracy information corresponding to the positioning data. Descriptions of step 310 may be referred to for more contents of determining of the positioning accuracy information corresponding to the positioning data, which may not be repeated herein.

The second determination module 220 may be configured for determining a degree of the confidence of the pose estimation data according to the positioning accuracy information. Descriptions of step 320 may be referred to for more contents of determining of the degree of the confidence of the pose estimation data, which may not be repeated herein.

The optimization module 230 may be configured for generating optimized pose data by processing the pose estimation data according to the degree of the confidence of the pose estimation data. Descriptions of step 330 may be referred to for more contents of processing on the pose estimation data to obtain the optimized pose data, which may not be repeated herein.

It should be understood that the system shown in FIG. 2 and the module thereof may be implemented in various ways. For example, in some embodiments, the system and the module thereof may be implemented through hardware, software or a combination of the software and the hardware. The hardware portion may be realized by utilizing a special logic. The software portion may be stored in the memory and executed by an appropriate instruction execution system, for example a microprocessor or special design hardware. It may be understood by those skilled in the art that the above method and system may be implemented using computer executable instructions and/or contained in a processor control code, for example, such a code may be provided on a carrier medium such as a magnetic disk, a compact disc (CD) or a digital video disk-read only memory (DVD-ROM), a programmable memory such as a read-only memory (firmware), or a data carrier such as an optical or electronic signal carrier. The system and the module thereof of the present application may be implemented by hardware circuits such as a very large-scale integrated circuit or a gate array, a semiconductor such as a logic chip and a transistor, or a programmable hardware device such as a field-programmable gate array and a programmable logic device, may be implemented by software executed by various types of processors as well, and may also be implemented by a combination of the above hardware circuit and software (for example, the firmware).

It should be noted that the above descriptions of the system for processing pose data and the modules thereof may be merely for convenience, and the present application is not be limited within the exemplified embodiments. It may be understood that for those skilled in the art, after understanding a principle of the system, it is possible to arbitrarily combine various modules or constitute a subsystem to connect a module to other modules without deviating from the principle. For example, in some embodiments, the first determination module 210, the second determination module 220 and the optimization module 230 disclosed in FIG. 2 may be different modules in one system, or one module realizing functions of the two or more modules above. For example, the first determination module 210 and the second determination module 220 may be two modules, or one module which may have both functions of determining the positioning accuracy information corresponding to the positioning data and determining the degree of the confidence of the pose estimation data at the same time. For example, the modules may share a storage module, or have their own storage modules. All such variations fall within the protection scope of the present application.

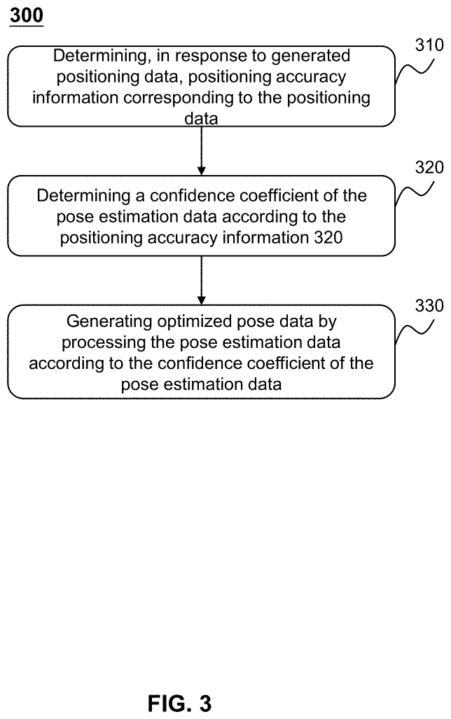

FIG. 3 is an exemplary flowchart of a method for processing pose data according to some embodiments of the present application.

The method for processing pose data may be applied to a map generation device. The map generation device may be provided with a global positioning system and a pose sensing system. The global positioning system may be configured for outputting positioning data, and the pose sensing system may be configured for outputting motion pose data. Detailed descriptions of the map generation device may be found in FIG. 4 and FIG. 5, which may not be repeated herein. Detailed descriptions of the positioning data and the motion pose data may be provided in step 310.

As shown in FIG. 3, the method for processing pose data may include the following steps.

In step 310, in response to generated positioning data, positioning accuracy information corresponding to the positioning data may be determined. Specifically, step 310 may be performed by the first determination module 210.

The positioning data may include all the data (such as a three-dimensional coordinate position generated by the global positioning system based on a communication signal of a positioning satellite) that may be used for positioning a subject. The motion pose data may include all the data (such as a motion trajectory, a speed, an acceleration, etc.) related to a motion or a pose. In some embodiments, the pose estimation data may be determined by combining the positioning data and the motion pose data. The pose estimation data may include six-dimensional parameters including an absolute position in the north, an absolute position in the east, an absolute position towards ground, a roll angle, a pitch angle, and a yaw angle. The roll angle refers to an included angle of a fuselage of the map generation device rolling horizontally to left and right sides, and has a range of (−180°, 180°]. The pitch angle may be an included angle formed between a direction of the fuselage of the map generation device and a horizontal direction, and has a range of [−90°, 90° ]. The yaw angle may be an included angle formed between a direction of a head of the map generation device and a preset heading, and has a range of (−180°, 180° ].

While the positioning data may be generated, corresponding positioning accuracy information may be determined. Optionally, the positioning accuracy information may include a positional dilution of precision (PDOP, which may be three-dimensional/spatial positional accuracy information, such as factors including a longitude, a latitude, an elevation, etc.), a horizontal positional dilution of precision (HDOP, such as factors including a longitude and a latitude), and a vertical positional dilution of precision (VDOP, such as a factor of an elevation). The above dilutions of precision (also referred to as factors of precision) may be usually proportional to the positioning accuracy information, that is, the smaller the dilution of precision is, the smaller an error of the positioning data corresponding to the positioning accuracy information may be, and the higher the positioning accuracy may be.

In some embodiments, the first determination module 210 may determine, in response to the generated positioning data, positioning accuracy information corresponding to the positioning data.

In step 320, a degree of the confidence of the pose estimation data may be determined according to the positioning accuracy information. Specifically, step 320 may be performed by the second determination module 220.

In some embodiments, the degree of the confidence of the pose estimation data may represent reliability of the pose estimation data. The higher the degree of the confidence is, the more reliable the pose estimation data may be, and the smaller the error of pose estimation data may be. In some embodiments, the second determination module 220 may determine a degree of the confidence of the pose estimation data according to the positioning accuracy information. Specifically, the second determination module 220 may input the positioning accuracy information, the positioning data and the motion pose data into an Unscented Kalman Filter (UKF), and may determine front-end mileage estimation data and a covariance matrix corresponding to the pose estimation data. The Unscented Kalman Filter may be a combination of unscented transformation and a standard Kalman filtering system. Through unscented transformation, nonlinear system equations may be applied to the standard Kalman filtering system under linear assumption. The front-end mileage estimation data may be the next-section driving trajectory data estimated by the Unscented Kalman Filter, and the front-end mileage estimation data may be different from an actual driving trajectory.

In some embodiments, the second determination module 220 may further perform a division operation on the front-end mileage estimation data to determine each of one or more groups of point clouds, and construct a corresponding pose graph according to each of the one or more groups of point clouds. The pose graph consists of nodes (or vertices) and edges. The nodes may correspond to pose data of a certain position, and the edges may correspond to pose variation data between two nodes. Generally, the front-end mileage estimation data may be divided based on the motion trajectory collected in real time by the laser sensor (belonging to a pose sensing system), so as to generate each of the one or more groups of point clouds (blocks), which may not be limited to the above division operation. During the process of the division, lengths of sections of motion trajectories may be adaptively determined according to the positioning accuracy information. For example, the smaller the dilution of precision may be (that is, the smaller the error of the positioning data is), the larger division granularity (a length of a route section/a duration for traversing the route section) of a corresponding section of motion trajectory may be. After the above division process may be completed, each section of the continuous motion trajectory may be determined as a node of the pose graph, which may be optimized.

In some embodiments, the second determination module 220 may determine one or more groups of point clouds by performing a time-space coherence division on the front-end mileage estimation data, and construct a corresponding pose graph according to each of the one or more groups of point clouds. Specifically, the second determination module 220 may divide the front-end mileage estimation data according to a preset time interval (for example, 1 second, 2 seconds or 3 seconds) to obtain a plurality of groups of point clouds divided according to a preset time interval. The pose variation data among the plurality of groups of point clouds may be edges of a first type in the pose graph, that is, temporal correlation of each group of point clouds may be reflected through generating the edges of the first type. Accordingly, the second determination module 220 may divide the front-end mileage estimation data according to the preset space interval (for example, 3 m, 5 m or 7 m) to obtain a plurality of groups of point clouds divided according to the preset space interval, and pose variation data among the plurality of groups of point clouds may be the edges of the second type in the pose graph. Relative pose transformation information (usually a transformation matrix) between two groups of point clouds may be calculated according to shapes of the two groups of point clouds, such that the two groups of point clouds subjected to transformation may be aligned. Therefore, the edges of the second type may be generated to reflect spatial position correlation of each group of point clouds. By performing the time-space coherence division on the front-end mileage estimation data, a plurality of point clouds may be divided into a same group. By replacing processing each group of point clouds with processing a single frame of point clouds, a calculation amount of the pose data processing system 100 may be reduced. Optionally, the second determination module 220 may also analyze a motion trajectory contained in the motion pose data, generate, through splicing, each group of point clouds according to continuity of the motion trajectory, and determine a first frame of point cloud in each group of point clouds as a vertex of the pose graph. The motion trajectory may be a motion trajectory acquired in real time by a laser sensor (or a laser radar, belonging to a pose sensing system). To sum up, for groups of point clouds adjacent in time domain, the pose graph divided along the motion trajectory may include the edges of the first type and the edges of the second type. For groups of point clouds not adjacent in time domain, the pose graph divided along the motion trajectory merely have the edges of the second type.

In some embodiments, the second determination module 220 may also determine the degree of the confidence of the pose estimation data based on the covariance matrix output by the Unscented Kalman Filter and the pose graph. The degree of the confidence of the pose estimation data may include degree of the confidences corresponding to the edges of the first type and degree of the confidences of the edges of the second type, that is, information matrix of the edges of the first type and information matrix of the edges of the second type. FIG. 4 and descriptions thereof may be referred to for more contents of determining of the degree of the confidence of the pose estimation data, which may not be repeated in the present application.

In step 330, optimized pose data may be generated by processing the pose estimation data according to the degree of the confidence of the pose estimation data. Specifically, step 330 may be performed by the optimization module 230.

In some embodiments, the optimization module 230 may correct a three-dimensional position of each group of point clouds in the pose graph according to the information matrix of the edges of the first type and the information matrix of the edges of the second type, that is, the pose estimation data in the pose graph may be optimized. If a covariance in the information matrix of the edges of the first type or the edges of the second type may be relatively large, weights of the edges of the first type or the edges of the second type are also high, and a correction amplitude may be reduced. Otherwise, the correction amplitude may be increased. Specifically, the optimization module 230 may comprehensively consider the covariance in the information matrix of the edges of the first type or the edges of the second type, so as to optimize the pose estimation data in the pose graph. For example, the weights of the edges of the first type and the weights of the edges of the second type may be set as 70% and 30%, respectively, and a correction amplitude may be determined accordingly, so as to optimize the pose estimation data in the pose graph. The optimized pose data obtained by processing the pose estimation data may be configured for nonlinear optimization on the pose graph. That is, by adjusting positions of all vertices in the pose graph, constraints of all edges may be satisfied as much as possible, and optimal vertex positions under all constraints may be obtained.

Further, in addition to adaptively adjusting an optimization degree of each group of point clouds in the optimization process of pose graph according to the degree of the confidence of the pose estimation data, a data collection mode, such as a data acquisition dimension, a data acquisition cycle, a data acquisition interval, data acquisition accuracy and data noise reduction parameters, of a navigation device may also be adjusted according to the degree of the confidence.

During optimization of the pose estimation data, pose estimation data in a area having weak GPS signals may be adjusted emphatically, thereby improving accuracy and reliability of the three-dimensional position of each group of point clouds and reducing the hierarchical phenomenon during optimization of the pose graph.

It should be noted that the above description related to the process 300 may be merely for illustration, and not intended to be limiting. For those skilled in the art, under the guidance of the present application, various modifications and changes may be made to the process 300. However, these modifications and changes may be still within the scope of the present application. For example, the preset time interval and/or the preset space interval may not be limited to values listed in step 320, but may be other values.

FIG. 4 is an exemplary flowchart of a method for determining a degree of the confidence of pose estimation data according to some embodiments of the present application. In some embodiments, the method for determining the degree of the confidence of the pose estimation data may be performed by a second determination module 220.

As shown in FIG. 4, the method for determining the degree of the confidence of the pose estimation data may include the following steps.

In step 410, an inverse matrix of a covariance matrix output by an Unscented Kalman Filter (UKF) may be determined, and the inverse matrix may be recorded as an information matrix of edges of a first type.

In some embodiments, the second determination module 220 may perform a matrix inversion on the covariance matrix output by the Unscented Kalman Filter to obtain the inverse matrix of the covariance matrix, and record the inverse matrix as the information matrix of the edges of the first type. It may be understood that a degree of the confidence of the pose estimation data may be implied in a pose covariance result output by the Unscented Kalman Filter.

The purpose of determining the information matrix of the edges of the first type may be to assign each edge of the first type a corresponding weight after the edges of the first type may be generated, so as to determine a corresponding correction amplitude when a pose graph may be optimized. Specifically, if a covariance in the information matrix of the edges of the first type is relatively large, the weights of the edges of the first type may be also high, and the correction amplitude may be decreased. Otherwise, the correction amplitude may be increased.

Further, since the covariance matrix output by the Unscented Kalman Filter also implies the degree of the confidence, in combination with the foregoing, the degree of the confidence may be essentially dependent on positioning data, motion pose data and positioning accuracy information. Moreover, the degree of the confidence may be essentially determined by a strength of a GPS signal and a measurement error. Therefore, by generating the information matrix of the edges of the first type and the information matrix of the edges of the second type, weights of various edges in the pose graph may be adjusted according to the GPS signal intensity and the measurement error, thereby improving reliability and positioning accuracy of positions of vertices in the pose graph, and reducing a hierarchical phenomenon during optimization of the pose graph.

In some embodiments, the information matrix of the edges of the first type may be determined according to a preset hardware parameter of a map generation device and/or a signal intensity of the positioning data. Specifically, a parameter dimension of the pose estimation data may be determined according to the preset hardware parameter of the map generation device and/or the signal intensity of the positioning data. A preset weight corresponding to each of the parameter dimension may be set as a value of a diagonal matrix, and the information matrix of the edges of the first type may be determined according to the diagonal matrix. In some embodiments, the parameter dimension includes at least one of an absolute position in the north, an absolute position in the east, an absolute position towards ground, a roll angle, a pitch angle, and a yaw angle. For example, the information matrix of the edges of the first type may use the following sixth-order diagonal matrix:

$$[ \begin{matrix}{σ}_{north}^{2} & & & & & \\ & {σ}_{east}^{2} & & & & \\ & & {σ}_{grounding}^{2} & & & \\ & & & {σ}_{roll}^{2} & & \\ & & & & {σ}_{pitch}^{2} & \\ & & & & & {σ}_{heading}^{2}\end{matrix} ]$$

Where σ²ₙₒᵣₜₕ, σ²ₑₐₛₜ, σ²_{grouding}, σ²ᵣₒₗₗ, σ²_{pitch} and σ²_{heading} represent covariance corresponding to the absolute position in the north, the absolute position in the east, the absolute position towards ground, the roll angle, the pitch angle and the yaw angle, respectively.

In the above technical solution, the information matrix of the edges of the first type may be determined according to the preset hardware parameter of the map generation device and/or the signal intensity of the positioning data. Since the preset hardware parameter of the map generation device and/or the signal intensity of the positioning data may be related to the strength of the GPS signal and the measurement error, weights of all the kinds of edges of the pose graph may be adjusted indirectly according to the strength of the GPS signal and the measurement error, thereby improving reliability and positioning accuracy of positions of vertices in the pose graph and reducing a hierarchical phenomenon during optimization of the pose graph.

In step 420, another inverse matrix of a covariance matrix generated during registration may be determined by performing a registration on any two groups of point clouds in the one or more groups of point clouds, and the another inverse matrix may be recorded as an information matrix of the edges of the second type.

In some embodiments, the second determination module 220 may perform a registration operation on any two groups of point clouds in all the groups of point clouds, perform a matrix inversion operation on the covariance matrix generated during the registration to obtain the inverse matrix of the covariance matrix, and record the inverse matrix as the information matrix of the edges of the second type. The registration of point clouds may be a transformation that aligns two groups of point clouds. The transformation may correspond to a transformation matrix, e.g., the covariance matrix. For example, the information matrix of the edges of the second type may use the following sixth-order diagonal matrix:

$$[ \begin{matrix}{σ}_{T}^{2} & 0 & 0 & 0 & 0 & 0 \\ 0 & {σ}_{T}^{2} & 0 & 0 & 0 & 0 \\ 0 & 0 & {σ}_{T}^{2} & 0 & 0 & 0 \\ 0 & 0 & 0 & {σ}_{R}^{2} & 0 & 0 \\ 0 & 0 & 0 & 0 & {σ}_{R}^{2} & 0 \\ 0 & 0 & 0 & 0 & 0 & {σ}_{R}^{2}\end{matrix} ]$$

Where σ_{T}² in the first column vector, the second column vectors and the third column vectors may be a covariance corresponding to a relative position in the north, covariance corresponding to a relative position in the east and covariance corresponding to a relative position towards ground, respectively, and σ_{R}² in the fourth column vectors, the fifth column vectors, and the sixth column vectors may be covariance corresponding to a relative roll angle, covariance corresponding to a relative pitch angle, and covariance corresponding to a relative yaw angle, respectively.

Similar to pose optimization logic of the edges of the first type, if the covariance in the information matrix of the edges of the second type may be relatively large, weights of the edges of the second type may be also high, and a correction amplitude may be reduced, otherwise, the correction amplitude may be increased.

It should be noted that the above description related to a flow 400 may be merely for examples and description, and does not limit the applicable scope of the present application. For those skilled in the art, under the guidance of the present application, various modifications and changes may be made to the flow 400. However, these modifications and changes may be still within the scope of the present application. For example, the information matrix of the edges of the first type and/or the information matrix of the edges of the second type may not be limited to the sixth-order diagonal matrix, but may also be a diagonal matrix of another order, or may also be a non-diagonal matrix of the sixth-order.

FIG. 5 is a schematic block diagram of a map generation device according to some embodiments of the present application.

As shown in FIG. 5, the map generation device 500 may include a memory 502, a controller 504, and a computer program which may be stored in the memory 502 and may run on the server. The controller 504 may implement steps defined by the method for processing pose data of any one in the present application when executing the computer program, and/or includes the pose data processing system 100 shown in FIG. 1. The map generation device 500 may include a navigation device 506, and the navigation device 506 may include a global positioning system 5061 and a pose sensing system 5062. In some embodiments, the global positioning system 5061 may include a positioning board and a satellite communication antenna, the positioning board and the satellite communication antenna may be configured to collect a three-dimensional position and a heading angle of the map generation device 500 in an earth coordinate system, where the heading angle may include the roll angle, the pitch angle and the yaw angle above. In some embodiments, the pose sensing system 5062 may include at least one or more of a vision sensor, a laser sensor and an inertial sensor, and the vision sensor, the laser sensor and the inertial sensor may be combined to collect a speed, a motion trajectory and acceleration.

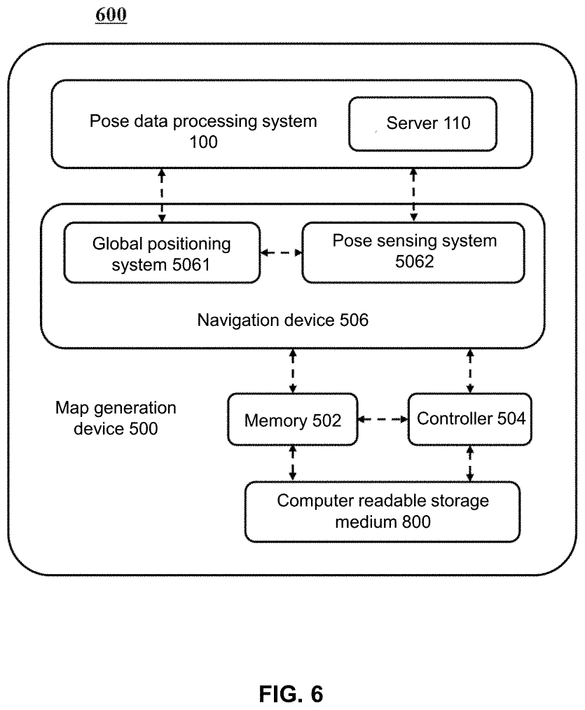

FIG. 6 is a schematic block diagram of a map generation device according to some other embodiments of the present application.

The present application further provides a computer readable storage medium 800, on which a computer program may be stored, and when the computer program may be read by the map generation device 500, the steps defined by the method for processing pose data of any one in the present application may be implemented.

In some embodiments, the map generation device 500 may be a whole device integrating portions, that is, the portions may be integrated into a whole. For example, the portions in the map generation device 500 may be located on the acquisition device 130. In some embodiments, the map generation device 500 may also be a device including scattered portions, that is, the portions or some portions may be independent systems, and the map generation device 500 may be merely a collective name of the systems. For example, the server 110 in the pose data processing system 100 may be located at a certain position (that is, a place centrally managed by the server) and the navigation device 506 may be located on the acquisition device 130.

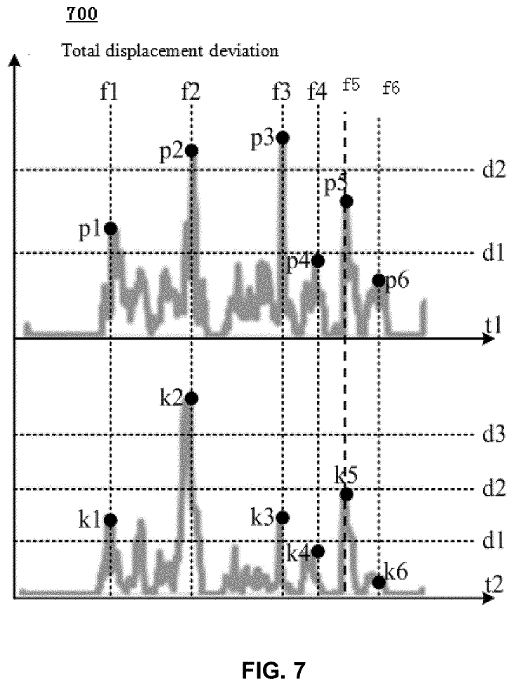

FIG. 7 is a schematic diagram illustrating the effect of optimizing pose estimation data according to some embodiments of the present application.

As shown in FIG. 7, a unit length of axis t1 and a unit length of axis t2 may use the same dimension and scale accuracy (f1, f2, f3, f4, f5 and f6), and a unit height of a total displacement deviation axis may also use the same dimension and scale accuracy (d1, d2 and d3). A degree of the confidence (weight) may not be introduced into kinds of edges in a corresponding pose graph above axis t1, but a degree of the confidence (weight) may be introduced into all kinds of edges in a corresponding pose graph above axis t2.

When strengths of GPS signals and measurement errors corresponding to calibration baseline f1 and calibration baseline f4 may be within normal ranges, correction amplitudes of a point cloud corresponding to point (area) p1 and point (area) k1 may be almost unchanged, and similarly, correction amplitudes of a point cloud corresponding to point (area) p4 and a point cloud corresponding to point (area) k4 may be almost unchanged.

When strengths of GPS signals corresponding to calibration baseline f2 and calibration baseline f5 may be relatively poor and measurement errors corresponding to calibration baseline f2 and calibration baseline f5 may be relatively large, with comparison with a correction amplitude of a point cloud corresponding to point (area) p2, a correction amplitude of a point cloud corresponding to point (area) k2 may be improved by introducing the degree of the confidence, and similarly, with comparison with a correction amplitude of a point cloud corresponding to point (area) p5, a correction amplitude of a point cloud corresponding to point (area) k5 may be improved by introducing the degree of the confidence.

When strengths of GPS signals corresponding to calibration baseline f3 and calibration baseline f6 may be relatively strong and measurement errors corresponding to calibration baseline f3 and calibration baseline f6 may be relatively small, with comparison with a correction amplitude of a point cloud corresponding to point (area) p3, a correction amplitude of a point cloud corresponding to point (area) k3 may be decreased by introducing the degree of the confidence, and similarly, comparing a correction amplitude of a point cloud corresponding to point (area) p6, a correction amplitude of a point cloud corresponding to point (area) k6 may be decreased by introducing the degree of the confidence.

The possible beneficial effects of the embodiment of the present application include, but are not limited to: the degree of the confidence of the pose estimation data may be determined, and then the edges of the pose graph may be set at different weights according to the degree of the confidence, so each group of point clouds may be correspondingly optimized during loop closure processing, thereby improving the optimization efficiency and reliability of the pose graph, reducing the hierarchical phenomenon of the point cloud data in the pose graph, and improving the accuracy and reliability of generating the high-definition map based on the pose estimation data. It should be noted that different embodiments may produce different beneficial effects. In different embodiments, the possible beneficial effects may be any one or a combination of several ones of the above, or any other possible beneficial effects.

Basic concepts may be described above, and it is obvious to those skilled in the art that the above detailed disclosure is merely an example and does not constitute a limit to the present application. Although not explicitly described herein, those skilled in the art may make various modifications, improvements and corrections to the present application. The modifications, improvements and corrections of this kind may be suggested in the present application, which still belong to the spirit and scope of exemplary embodiments of the present application.

Meanwhile, the present application uses specific words to describe the embodiments of the present application. For example, “an embodiment”, “one embodiment” and/or “some embodiments” mean a certain feature, structure or characteristic related to at least one embodiment of the present application. Therefore, it should be emphasized and noted that “one embodiment” or “an embodiment” or “an alternative embodiment” mentioned twice or more times in different places in the specification does not necessarily mean the same embodiment. In addition, some features, structures, or characteristics in one or more embodiments of the present application may be combined appropriately.

In addition, those skilled in the art may understand that various aspects of the present application may be illustrated and described by several patentable categories or situations, including any new and useful processes, machines, products or combinations of substances, or any new and useful improvement to the same. Accordingly, all aspects of the present application may be completely executed by hardware, software (including firmware, resident software, microcodes, etc.), or a combination of the hardware and the software. The above hardware or software may be called “a data block”, “a module”, “an engine”, “a unit”, “a component” or “a system”. Further, aspects of the present application may be embodied as a computer product located in one or more computer-readable media, the product including computer-readable program codes.

A computer storage medium may include a propagation data signal including a computer program code, for example, on baseband or as a portion of a carrier wave. The propagation signal may have various forms, including electromagnetic forms, optical forms, or suitable combination forms. The computer storage medium may be any computer readable medium except the computer readable storage medium, which may realize programs used by communication, propagation or transmission by being connected to an instruction execution system, apparatus or device. The program code located on the computer storage medium may be propagated through any suitable medium, including radio, cables, fiber optic cables, radio frequency, or similar media, or any combination of the above medium.

Computer program codes required for portions of operations of the present application may be written in any one or more programming languages, including object-oriented programming languages such as Java, Scala, Smalltalk, Eiffel, JADE, Emerald, C++, C#, VB.NET, Python, etc. Conventional programming languages include, for example, C language, Visual Basic, Fortran 2003, Perl, common business-oriented language (COBOL) 2002, Hypertext Preprocessor (PHP), advanced business application programming (ABAP), and dynamic programming languages include, for example, Python, Ruby and Groovy, or other programming languages. The program code may be completely run on a computer of a user, or on the computer of the user as an independent software package, or partially run on the computer of the user and partially run on a remote computer, or completely run on a remote computer or a server. In the latter case, the remote computer may be connected to the computer of the user through any network form, such as a local area network (LAN) or a wide area network (WAN), or connected to an outer computer (for example, through the Internet), or in a cloud computing environment, or used as a service such as software as a service (SaaS).

In addition, unless explicitly stated in the claims, an order of processing elements and sequences, use of numerals and letters, or use of other names described in the present application may not be configured to define orders of the flow and method in the present application. Although some invention embodiments presently considered useful may be discussed through various examples in the above disclosure, it should be understood that such details may be merely for the purpose of description, and the appended claims may not be limited to the disclosed embodiments. On the contrary, the claims may be intended to cover all modifications and equivalent combinations that conform to the essence and scope of the embodiments of the present application. For example, although system components described above may be implemented by hardware devices, they may also be implemented only by software solutions, such as through mounting of the described system on an existing server or a mobile device.

Similarly, it should be noted that in order to simplify expressions disclosed in the present application and help to understand one or more invention embodiments, in the foregoing description of the embodiments of the present application, various features may be incorporated into one embodiment, accompanying drawing or descriptions thereof sometimes. However, this disclosure method does not mean that the subject of the present application needs features more than those mentioned in the claims. In fact, the features of an embodiment may be less than all features of a single embodiment disclosed above.

In some embodiments, numbers describing the number of components and attributes may be used. It should be understood that in some examples, such numbers describing the embodiment may be modified by the modifiers “about”, “approximately” or “substantially”. Unless otherwise stated, “about”, “approximately” or “substantially” means that the number is allowed to vary by ±20%. Accordingly, in some embodiments, numerical parameters used in the specification and claims may be approximate values, and the approximate values may be changed according to features required by an individual embodiment. In some embodiments, the numerical parameters should consider the specified significant digits and use a general digit keeping method. Although numerical fields and parameters configured to confirm a range breadth in some embodiments of the present application may be approximate values, in specific embodiments, the setting of such numerical values is as accurate as possible to the extent feasible.

For each patent, patent application, patent application publication and other materials cited in the present application, such as an article, a book, a specification, a publication and a document, their entire contents may be incorporated herein by reference. Historical documents of the present application which may be inconsistent or conflict with the content of the present application may be excluded, and documents (currently or later attached to the present application) which limit the widest scope of the claims of the present application may be excluded as well. It should be noted that if there is any inconsistency or conflict between descriptions, definitions and/or terms in materials attached to the present application and the content described in the present application, the descriptions, definitions and/or terms in the present application shall prevail.

Finally, it should be understood that the embodiments described in the present application may be merely configured to describe the principle of the embodiments of the present application. Other variations may also fall within the scope of the present application. Therefore, as an example instead of a limit, alternative configurations of the embodiments of the present application may be considered consistent with instructions of the present application. Accordingly, the embodiments of the present application may not be merely limited to the embodiments explicitly introduced and described in the present application.

1. A method for processing pose data; the method being applied to a map generation device, the map generation device being coupled to a global positioning system and a pose sensing system, the global positioning system being configured for outputting positioning data; the pose sensing system being configured for outputting motion pose data, and the positioning data and the motion pose data being combined to generate pose estimation data, wherein the method for processing pose data comprises:
determining; in response to the generated positioning data, positioning accuracy information corresponding to the positioning data;
determining a degree of confidence of the pose estimation data according to the positioning accuracy information; and
generating optimized pose data by processing the pose estimation data according to the degree of the confidence of the pose estimation data.

2. The method of claim 1; wherein the determining a degree of the confidence of the pose estimation data according to the positioning accuracy information comprises:
generating front-end mileage estimation data and a covariance matrix corresponding to the pose estimation data by inputting the positioning accuracy information, the positioning data, and the motion pose data into an Unscented Kalman Filter (UKF);
determining one or more groups of point clouds by performing a time-space coherence division on the front-end mileage estimation data, and constructing a corresponding pose graph according to each of the one or more groups of point clouds; and
determining the degree of the confidence of the pose estimation data based on the covariance matrix and the pose graph.

3. The method of claim 2, wherein the determining one or more groups of point clouds by performing a time-space coherence division on the front-end mileage estimation data, and constructing a corresponding pose graph according to each of the one or more groups of point clouds comprise;
determining edges of a first type in the pose graph by dividing the front-end mileage estimation data according to a preset time interval;
determining edges of a second type in the pose graph by dividing the front-end mileage estimation data according to a preset space interval; and
resolving a motion trajectory from the motion pose data, generating, through splicing, each of the one or more groups of point clouds according to a continuity of the motion trajectory, and determining a first frame of point cloud in each group of point clouds as a vertex of the pose graph.

4. The method of claim 3, wherein the determining the degree of the confidence of the pose estimation data based on the covariance matrix and the pose graph comprises:
determining an inverse matrix of the covariance matrix output by the Unscented Kalman Filter, and recording the inverse matrix as an information matrix of the edges of the first type; and
determining another inverse matrix of the covariance matrix generated during registration by performing a registration on any two groups of point clouds in the one or more groups of point clouds, and recording the another inverse matrix as an information matrix of the edges of the second type.

5. The method of claim 4, wherein the determining an inverse matrix of the covariance matrix output by the Unscented Kalman Filter, and recording the inverse matrix as an information matrix of the edges of the first type comprise:
determining the information matrix of the edges of the first type according to at least one of at least one preset hardware parameter of the map generation device or a signal intensity of the positioning data.

6. The method of claim 4, wherein the generating optimized pose data by processing the pose estimation data according to the degree of the confidence of the pose estimation data comprises:
correcting a three-dimensional position of each group of point clouds in the pose graph according to the information matrix of the edges of the first type and the information matrix of the edges of the second type.

7. The method of claim 5, wherein the determining the information matrix of the edges of the first type according to at least one of at least one preset hardware parameter of the map generation device or a signal intensity of the positioning data comprises:
determining a parameter dimension of the pose estimation data according to at least one of the preset hardware parameter of the map generation device or the signal intensity of the positioning data; and
setting a preset weight corresponding to the parameter dimension as a value of a diagonal matrix, and determining the information matrix of the edges of the first type according to the diagonal matrix.

8. The method of claim 7, wherein
the parameter dimension comprises at least one of an absolute position in the north, an absolute position in the east, an absolute position towards ground, a roll angle, a pitch angle, or a yaw angle.

9. The method of claim 1, wherein
the pose sensing system comprises at least one of a vision sensor, a laser sensor, or an inertial sensor.

10. A system for processing pose data, the system being applied to a map generation device, the map generation device being coupled to a global positioning system and a pose sensing system, the global positioning system being configured for outputting positioning data, the pose sensing system being configured for outputting motion pose data, and the positioning data and the motion pose data being combined to generate pose estimation data, wherein the system for processing pose data comprises:
at least one memory for storing a computer instruction; and
at least one processor in communication with the memory, wherein when the at least one processor executes the computer instruction, the at least one processor enables the system to execute:
determining, in response to generated positioning data, positioning accuracy information corresponding to the positioning data;
determining a degree of confidence of the pose estimation data according to the positioning accuracy information; and
generating optimized pose data by processing the pose estimation data according to the degree of the confidence of the pose estimation data.

11. The system of claim 10, wherein in order to determine the degree of the confidence of the pose estimation data, the at least one processor enables the system to further execute:
generating front-end mileage estimation data and a covariance matrix corresponding to the pose estimation data by inputting the positioning accuracy information, the positioning data and the motion pose data into an Unscented Kalman Filter (UKF);
determining one or more groups of point clouds by performing a time-space coherence division on the front-end mileage estimation data, and constructing a corresponding pose graph according to each of the one or more groups of point clouds; and
determining the degree of the confidence of the pose estimation data based on the covariance matrix and the pose graph.

12. The system of claim 11, wherein in order to construct the corresponding pose graph according to each group of point clouds, the at least one processor enables the system to further execute:
determining edges of a first type in the pose graph by dividing the front-end mileage estimation data according to a preset time interval;
determining edges of a second type in the pose graph by dividing the front-end mileage estimation data according to a preset space interval; and
resolving a motion trajectory from the motion pose data, generating, through splicing, each of the one or more groups of point clouds according to a continuity of the motion trajectory, and determining a first frame of point cloud in each group of point clouds as a vertex of the pose graph.

13. The system of claim 12, wherein in order to determine the degree of the confidence of the pose estimation data based on the covariance matrix and the pose graph, the at least one processor enables the system to further execute:
determining an inverse matrix of the covariance matrix output by the Unscented Kalman Filter, and recording the inverse matrix as an information matrix of the edges of the first type; and
determining another inverse matrix of the covariance matrix generated during registration by performing a registration on any two groups of point clouds in the one or more groups of point clouds, and recording the another inverse matrix as an information matrix of the edges of the second type.

14. The system of claim 13, wherein in order to determine the inverse matrix of the covariance matrix output by the Unscented Kalman Filter, and record the inverse matrix as the information matrix of the edges of the first type, the at least one processor enables the system to further execute:
determining the information matrix of the edges of the first type according to at least one of at least one preset hardware parameter of the map generation device or a signal intensity of the positioning data.

15. The system of claim 13, wherein in order to generate optimized pose data by processing the pose estimation data according to the degree of the confidence of the pose estimation data, the at least one processor enables the system to further execute:
correcting a three-dimensional position of each group of point clouds in the pose graph according to the information matrix of the edges of the first type and the information matrix of the edges of the second type.

16. The system f claim 14, wherein in order to determine the information matrix of the edges of the first type according to at least one of the at least one preset hardware parameter of the map generation device or the signal intensity of the positioning data, the at least one processor enables the system to further execute:
determining a parameter dimension of the pose estimation data according to at least one of the preset hardware parameter of the map generation device or the signal intensity of the positioning data; and
setting a preset weight corresponding to the parameter dimension as a value of a diagonal matrix, and determining the information matrix of the edges of the first type according to the diagonal matrix.

17. The system of claim 16, wherein
the parameter dimension comprises at least one of an absolute position in the north, absolute position in the east, an absolute position towards ground, a roll angle, a pitch angle and a yaw angle.

18. The system of claim 10, wherein
the pose sensing system comprises at least one of a vision sensor, a laser sensor, or an inertial sensor.

19-20. (canceled)

21. A non-transitory computer readable storage medium, comprising a set of instructions for processing pose data, wherein when executed by at least one processor, the set of instructions directs the at least one processor to:
determine, in response to generated positioning data, positioning accuracy information corresponding to positioning data;
determine a degree of the confidence of pose estimation data according to the positioning accuracy information; and
generating optimized pose data by processing the pose estimation data according to the degree of the confidence of the pose estimation data.

22. The non-transitory computer readable storage medium of claim 21, wherein determining the degree of the confidence of the pose estimation data according to the positioning accuracy information comprises:
generating front-end mileage estimation data and a covariance matrix corresponding to the pose estimation data by inputting the positioning accuracy information, the positioning data and motion pose data into an Unscented Kalman Filter (UKF);
determining one or more groups of point clouds by performing a time-space coherence division on the front-end mileage estimation data, and constructing a corresponding pose graph according to each of the one or more groups of point clouds; and
determining the degree of the confidence of the pose estimation data based on the covariance matrix and the pose graph.
